(19) United States
(12) Patent Application Publication
(10) Pub. No.: US 2019/0330047 A1
(43) Pub. Date: Oct. 31, 2019

(54) METHOD AND SYSTEM FOR MONITORING, MANAGING, AND CONTROLLING FUEL DISPENSERS

(71) Applicant: Site IQ, LLC, Lincolnshire, IL (US)

(72) Inventors: Arjun Kumar Joginipelly, Acworth, GA (US); Kishore Gangwani, Lincolnshire, IL (US); Bryant Elliot, Kennesaw, GA (US)

(21) Appl. No.: 16/392,349

(22) Filed: Apr. 23, 2019

Related U.S. Application Data
(60) Provisional application No. 62/662,244, filed on Apr. 25, 2018.

(51) Int. Cl. B67D 7/32; G05B 15/02; B67D 7/10; B67D 7/14; B67D 7/22

(52) U.S. Cl. CPC B67D 7/32; G05B 15/02; B67D 7/106; B67D 2007/329; B67D 7/224; B67D 7/3272; B67D 7/3245; B67D 7/145

(57) ABSTRACT

A dispenser interface module connects with an existing main processing board of a fuel dispenser via an existing data port of the main board and via a current loop communication link connection of the main board. The dispenser interface module determines an idle condition of the dispenser from analysis of signals on the link, without disturbing the signals on the link, and only performs actions such as reboot or software update of the main board, or retrieval of data from the main board through the data port, during the idle condition. The dispenser interface module may compress data retrieved through the data port by removing previously retrieved records from the retrieved data. The dispenser interface module instructs a communication module to wirelessly transmit the compressed data to a remote server for analysis. The communication module wirelessly receives, and forwards to the dispenser interface module, reboot or update messages and instructions.

### CROSS REFERENCE TO RELATED APPLICATION

This application claims priority under 35 U.S.C. 119(e) to U.S. provisional patent application No. 62/662,244 entitled “Fuel pump dispensing device and a method for the same,” which was filed Apr. 25, 2018, which is incorporated herein by reference in its entirety.

### FIELD

The field relates, generally, to Internet of Things systems and devices and, more particularly, to a system and method for detecting and processing signals to and from fuel dispensers, and to managing, updating, and controlling the dispensers.

### BACKGROUND

A typical fuel station includes at least one fuel dispenser to facilitate a user filling his or her vehicle's fuel tank with fuel such as gasoline, diesel, CNG, CGH2, HCNG, LPG, LH2, ethanol fuel, biofuels like biodiesel, kerosene, hydrogen, electricity, and the like. Gasoline fuel dispensers may include Push to Select (“PTS”) buttons to allow a user to select a desired fuel grade to be delivered to a vehicle. Typical fuel dispensers include an electronics compartment and a pump compartment. The pump compartment typically houses a pump configured to pump fuel from a fuel tank or other reservoir, usually below ground, as well as one or more meters that monitor fuel flow. The electronics compartment typically includes PTS buttons and fuel dispenser user interface coupled for displaying a total cost and volume of fuel dispensed. The electronics compartment also typically includes a payment terminal that interfaces with a user for facilitating payment for fuel and other items. In some cases, the payment terminal can be separate from the fuel dispenser. In some cases, the payment terminal may be part of a user interface, such as an application running on a touch screen, into which a user may enter information and from which a user may receive information.

The electronics compartment also typically includes a fuel controller in communication with sensors from the pump compartment, and a computer device is typically located in a building substantially collocated with the at least one dispenser. The controller may communicate information and data to and from a computer device, such as a point-of-sale (“POS”) system server in a fuel station building at the site of the fuel dispenser.

A user can provide payment information (e.g., credit card information) using the payment terminal, and payment information can be via a controller to a POS system for verification. Once the payment information is verified, the POS can notify the fuel pump controller, which can initiate fueling. The fuel pump controller delivers data characterizing the running cost and the amount of fuel that has been dispensed to the output terminal to provide the information to the user.

An abnormal condition of a fuel dispenser, at a gas station for example, may occur due to faulty components, user error or damage, and a variety of other reasons, and may require repair. Because of tediousness or difficulty in determining that an abnormal condition exists at a fuel dispenser, fuel dispensers sometimes remain unrepaired or unattended to, especially if basic functions of the fuel dispenser (i.e., ability to pump gas and receive payment therefore) continue to operate. Some of the variety of factors that may cause an abnormal condition of a fuel dispenser include lightning, severe temperature, humidity, tampering, power supply voltage fluctuation, a customer driving away from a fuel dispenser with a fuel nozzle still inserted into his or her vehicle and tearing the fuel nozzle hose from the dispenser, etc. When a dispenser is damaged or some other sort of abnormal condition exists at the dispenser, a display of the user interface at the dispenser may display error codes or messages.

### SUMMARY

Data and information may be communicated between a fuel dispenser and a computer device located inside a building proximate to the dispenser, or between a fuel dispenser fleet management system server that may be located remotely from the site of the fuel dispenser and related building/structure.

Means for communicating data and information with a computer device located close to a dispenser may include a two-wire current loop communication link. The data and information communicated via the two-wire current loop may include information associated with a customer's use of a given fuel dispenser. Error codes, log files, and other information associated with the dispenser may be generated during use of the dispenser, or merely while the dispenser is in service awaiting use by a customer. A novel dispenser interface module may retrieve error codes, log files, and other information from an existing main board of the dispenser via a serial port connection, such as an RS-232, RS-485, USB, and the like while the dispenser is idle, and the novel dispenser interface may transmit the codes, files, and other information via a communication module. The dispenser interface module may receive commands to cause an action with the dispenser, for example to reboot the dispenser's existing main board.

A fuel dispenser controller at a dispenser server, (the controller and server may be collectively referred to herein as just a server) which typically is located in a gas station/fueling station building at the site of the dispenser, may control the operation of a plurality of associated fuel pump dispensers at the filling/fueling station, or gas station. The dispenser controller/server may be located remotely from the filling station. The fuel dispenser controller/server may control the operation of the associated fuel pump dispensers by sending commands and time-based controls to associated fuel pump dispensers via the two-wire current loop. The commands and the time-based controls may include, but are not limited to, cash register information, dispenser control commands, information related to preset amounts of fuel to dispense, and authorization to dispense fuel. Fuel pump dispensers typically provide services of providing fuel dispensing operations based on data corresponding to user inputs at the dispenser that are transmitted to the server/controller, apart from the commands and time-based control, using a Point-Of-Sale (POS) terminal that may be the same as, included as part or, or co-located with the dispenser controller/server. Data related to the authorization of use of, and dispensing of fuel from, a dispenser may correspond to, for example, current price of different types of fuels available and selected by a user, inventory management metrics, and the like.

Fuel pump dispensers, including those that may have been installed a considerable time ago, (i.e., legacy fuel pump dispensers) may incur damaged due to factors such as, but not limited to, lightning, temperature, humidity (typically corrosion), tampering, voltage fluctuations, wear and tear during its long functioning life, etc. Damage may manifest as malfunctioning fuel pump dispensers. Fuel pump dispensers at far off locations (i.e., remote locations far from repair technician dispatch hubs or depots), including the legacy fuel pump dispensers, may remain inoperable for considerable periods of time and become inoperable for dispensing fuel, which may lead to customer inconvenience and lost revenue to retail fueling premises operators.

Customer interactivity with a fuel dispenser may include choosing an option presented by the fuel dispenser controller through the associated fuel pump dispensers, which options may be facilitated as one or more services by a POS and may include options for ordering foods and services, such as, but not limited to, car washes, card readers for accepting payment for fuel, goods and services at the dispenser, user interface displays for ordering products, and commercial advertising.

A process for updating customer interactivity options and display enhancement may involve changing firmware or downloading new software to each of the plurality of fuel pump dispenser's main boards. Preferably software application revisions are provided to every fuel dispenser in a given operator's fleet of dispensers.

A dispenser interface module and a communication module associated with a given dispenser interface module facilitates remote, wireless updating of features and capabilities to a fleet of fuel dispenser managed by a fuel dispenser management server. A given dispenser interface module may perform edge computing locally so that information from the given fuel dispenser that is wirelessly transmitted to the remote management server does not include information that is associated with the particular dispenser that the server may already have received from a previous transmission of dispenser data from the given dispenser.

The novel dispenser interface module, which may be referred to as a pump board, may include circuitry configured to receive and process data from sensors of a fuel dispenser. Such sensors may include sensors for detecting humidity at a fuel station, door status (open or closed) sensors, storage tank fuel level metrics, environmental sensors, and the like. The dispenser interface module at each fuel dispenser may further include circuitry configured to receive sensed current values as data from a two-wire twisted pair current loop communication link that connects the main board and dispenser interface board at each dispenser with a dispenser server in the corresponding filling station using an asynchronous transceiver to convert a serial mode data stream on the current loop to a parallel data stream for further processing (such as edge computing processing) by the dispenser interface module and for communication to a remote management server via a communication network, such as a long-range wireless communication network. The dispenser interface module may further include other asynchronous transceiver circuitry configured to connect to an existing serial communication enabled interface on the dispensers existing main board to extract diagnostic data from the fuel dispenser's main board.

The dispenser interface module may further contain a microprocessor configured to collect sensed data from all legacy interfaces, including the existing diagnostic serial port of the main board and data from the asynchronous transceivers, and to analyze the data to extract information therefrom. The dispenser interface module may be configured to extract status information from the fuel pump dispenser' main board such as, but not limited to, health of a printer and display connected to the dispenser, calibration information of the plurality of the dispenser, and event log files pertaining to use or to a problem or malfunctioning of the dispenser during a given period of operation. The microprocessor of the dispenser interface module may compress the relevant information, acquire the sensor data, and control a cellular modem module of the communication module. The compression may be an example of edge computing performed by the processor of the dispenser interface module, and may include determining data records of a given log file that have already been uploaded to a management and analytics server via the communication module, deleting the previously-transmitted data records, and then forwarding only new data records to the management/analytics server. Without use of the novel dispenser interface module, past retrieving of log file data typically involved a technician physically visiting a given dispenser, opening a security door, connecting a computer device to a serial port of the dispenser's main board, and extracting the entire log file, including records that may have already been retrieved during a previous visit to the dispenser. Using edge computing at the dispenser interface module reduces the sending of redundant data using the wireless modem of the communication module. In addition, a dispenser's main board typically has a limit of how many records in a log file may be retained based on the board's local memory size if a number of records generated by a dispenser exceeded the amount of records that could be stored in a main board's on-board memory, and the oldest records would be lost as the new records are pushed into the log file thus causing the oldest records to be discarded from the memory. If a technician did not visit a given dispenser to download log files from the dispenser's main board before old records were discarded, the old records would be lost. By periodically causing the communication module disclosed herein to upload compressed data files (i.e., a version of a file, or of information stored on a main board's memory that contains only records generated since a previous upload operation), the novel dispenser interface module can facilitate preservation all log file data records without increasing a dispenser's main board memory size and without using wireless resources (i.e., wireless transmission air time billed by a wireless network operator) to transmit to a management and analytics server redundant data that the server already has.

The communication module cell board disclosed herein may include voltage regulators, data converters, an LTE CAT-M1 cellular modem, one or more antennas for providing a data-pipe to the servers and may be partially controlled by the dispenser interface module/pump board microprocessor.

The microprocessor in the dispenser interface pump board may perform the function of acquiring/detecting message information from a 4-50 mA two-wire current loop communication link communicated as UART data, and may connect to, and pull data from, a dispenser's main board's diagnostic serial port. Circuitry of the dispenser interface board may include multiple op-amps and comparators to parse UART data from signals detected on the two-wire communication link. The processor may further extract and compress the relevant information, acquire pump sensor data, and control the communication module cellular modem.

Communication between a dispenser server in a gas station store and one or more pumps/dispensers at the gas station typically is a half-duplex serial-link implemented with a 4-50 mA optocoupled two-wire interface. Circuitry of the dispenser interface module/pump board monitors signals on the two-wire current loop and generates UART information therefrom without interfering with, or disturbing, the communication of the signals between a given dispenser's main board and the server in the gas station building.

Send and receive functionality between a dispenser's main board and a gas station server is accomplished on the same wires of the two-wire current loop by establishing that a logic 1 is indicated/represented by a current level value between 4-20 mA, a logic 0 being indicated/represented by a current value about 50 mA for communication in one direction (e.g., pump transmission to the store server), and a logic 0 being indicated/represented by a current value about 4 mA for communication in other direction (e.g., store server transmission to the dispenser main board). It will be appreciated that the low logic 0 or high logic 0 may be implemented as corresponding to communication in either of the directions between the server and a dispenser. Circuitry of the novel dispenser interface module/pump board does not disturb current signals on the 4-50 mA current loop between a dispenser and gas station server. The circuitry monitors a differential voltage that the current signals develop across resistors at the dispenser and server ends of the current loop. The circuitry then re-creates the signals as UART signals and extracts the information being communicated between the store server and pump/dispenser main board. Preferably, the two wires of the current loop are formed as a twisted pair of conductors. Electrical noise injected into the current loop, which may typically be about 100 feet between a dispenser and a gas station server, is injected to both of the wires, but a high common mode rejection amplifier of the dispenser interface board effectively subtracts this noise before outputting a difference signal that corresponds to differences in current signals detected on the two-wire current loop.

In an aspect, a device for interfacing a main computing/processing board that is part of a fuel dispenser as supplied by an OEM of the dispenser comprises a first dispenser interface coupled to a first communication port of the main board of the fuel dispenser. The first communication port may be a serial port that is part of the dispenser's main board. A dispenser interface module may be coupled to the first dispenser interface. The first dispenser interface may be a serial port mounted to, or electrically coupled via wires to, the dispenser interface module. The first dispenser interface may be in communication with a dispenser interface module processor, such as a microprocessor, of the dispenser interface module. A communication module may be coupled with the dispenser interface module, via electrical conductors, or via a wireless link, and may be part of a circuit board that is different from a circuit board the includes circuitry of the dispenser interface module, or the communication module and the dispenser interface module may each comprise circuitry on a single circuit board. The dispenser interface module processor may be configured, programmed, or otherwise set up and connected with the dispenser interface to receive first dispenser data from the first dispenser interface. The first dispenser data may be in the form of serial data and may include log files, error codes, dispenser health information, and operational data of the dispenser, such as gallons of fuel, grade of fuel dispensed, time stamps of the dispensing of fuel, condition and status of tanks that contain fuel for the dispenser to dispense, and the like. The log files may include historical records that include operational data for multiple fuel transactions. Any, or all, of error code information, dispenser health information, operational data, and the like may be stored as log files, in various formats, including CSV, tabular, spreadsheet, database, and the like. The dispenser interface processor may be configured, programmed, or otherwise set up to process the first dispenser data to create first processed dispenser data and to cause the communication module to transmit the processed first dispenser data to an element of a communications network with which the communication module is configured to communicate when predetermined operational, or abnormal operational, condition is met, according . The processed first dispenser data may include data from log files that were compressed from log files such that the processed (e.g., compressed) first data includes only data generated by the dispenser since a previous retrieval, or since a previous communication by the communication module, of first dispenser data.

In an aspect, the communication module includes a long-range wireless communication modem for communicating the processed first data over a long-range wireless communication link, such as a link of a cellular telephony network, a packet core data network, and the like.

In an aspect, a second dispenser interface couples with a communication link between the fuel dispenser and a dispenser management station device, such as a computer server that interfaces with a plurality of dispensers at a given fuel station. The communication link includes a two-wire current loop, wherein the second dispenser interface couples to second dispenser interface circuitry to obtain second dispenser data from signals passing on the two-wire current loop. The second dispenser interface circuitry does not disrupt signals that pass between the dispenser and the dispenser management station on the two-wire current loop. The second dispenser interface circuitry may include a high impedance high common mode rejection ratio amplifier that senses differences in voltage levels of signals on the two-wire current loop that correspond to current signals on the current loop.

In an aspect, the dispenser interface module processor causes the communication module to transmit a message when the dispenser interface module processor determines that the first dispenser data, or the second dispenser data, indicate that the fuel dispenser has experienced an abnormal condition. In another aspect, the dispenser interface module processor causes the communication module to transmit a message according to a predetermined schedule, such as, for example, a periodic communication every 15 minutes.

In an aspect, the second dispenser interface couples to a high common mode rejection ratio differential amplifier circuit that detects the second dispenser data from the communication link between the fuel dispenser and the dispenser management station and provides the second dispenser data to the dispenser interface module processor.

In an aspect, the communication module includes a SIM that can operate on multiple mobile network operators' networks, and wherein the communication module includes a communication module processor to select which of the multiple mobile network operators' networks to operate on based on network metrics. The SIM may be a removable SIM device that can be inserted and removed from a slot, socket, or receptacle of a circuit board. Or, the SIM may be an eSIM. Either a SIM or an eSIM may be substantially permanently attached, soldered, bonded, or otherwise secured to a circuit board. An eSIM may be configured with the capability to use one of a plurality of profiles that correspond to one of a plurality of different wireless mobile networks. In an aspect, the SIM, or eSIM, may be operable not only for operation via multiple operators' long-range wireless networks, but may be operable on different networks that operate according to different long-range wireless technologies. Thus, a processor of the communication module can determine that a plurality of wireless networks, or wireless networking technologies, are available for communication use, and a processor of the communication module may select one of the plurality of networks for use in communicating, for example, processed first dispenser data according to rule criteria, such as signal strength thresholds, current network usage metrics, data transmission cost for use of a given network, and the like.

In an aspect, the first dispenser data includes at least one data file, wherein the dispenser interface module processor is further configured, programmed, or otherwise set up to compare a current version of one of the at least one data file, or files, to a previous version of the one of the at least one data file, or files, and to cause the communication module to transmit only differences between the current version and the previous version of the one of the at least one data file, or files.

In an aspect, the data condition is met when the first or second dispenser data indicate that the dispenser has experienced an abnormal condition.

In an aspect, the processed first dispenser data includes less than all of the first dispenser data, wherein the processed first dispenser data includes first dispenser data that is relevant to a particular desired recipient and does not include first dispenser data that is not relevant to the particular desired recipient. For example, a manager or owner of the fuel station where the dispenser is located may be interested in gallons of fuel dispensed but isn't interested in particular mechanical problems that exists with a pump of the dispenser, whereas an entity that is responsible for repairing fuel dispensers may be interested in error codes related to the dispenser that can be used to determine what type of tools, replacement parts, or technician may be needed to repair a given dispenser.

In an aspect, a method comprises the steps of monitoring, with a dispenser interface module, dispenser signal levels of a main board of a fuel dispenser via a current loop connection and managing the main board with the dispenser interface module. The monitoring may include detecting voltage levels of signals on a two-wire current loop between a fuel dispenser and a fuel station server, where the voltage levels correspond to current levels of the signals on the current loop. The monitoring may include translating the detected voltage levels into logical ones and zeros. The monitoring may include determining whether the ones or zeros indicate that the fuel dispenser is currently being used, or not, by a customer, such as a consumer at a retail gas station using the fuel dispenser to add gasoline or diesel fuel to his or her automobile.

In an aspect, the managing of the main board may include transmitting message signals from the dispenser interface module to the main board but does not include transmitting communication signals from the dispenser interface module to the main board via the current loop connector. In an aspect, the dispenser interface module only detects signals and gleans information from the signals on the current loop; the dispenser interface module preferably does not interfere with, or disrupt signals being communicated between the dispenser and the gas station server on the loop. The dispenser interface module preferably does not inject signals on, transmit signals to, or otherwise place information signals on conductors of the two-wire current loop.

In an aspect, the managing of the main board includes interrupting power to the main board only when the monitoring of the pump signal levels indicates that the fuel dispenser is idle. It would be undesirable to cause a reboot of the dispenser's main board while a customer was pumping gas into his or her automobile. From the customer's perspective the filling of the fuel tank would be delayed, and from the perspective of the owner/operator of the fuel station any fuel already dispensed to the customer's fuel tank might be unaccounted for and would essentially amount to the customer receiving fuel without paying for it. Sometimes a reboot of the main board of a dispenser is all that is needed to correct an error condition of the main board, but by only causing a reboot when signals on the current loop indicate that the dispenser is idle the dispenser interface module avoids causing undesirable fuel dispensing occurrences.

In an aspect, the current loop connection includes, or may be part of, a y-harness that connects a station's existing current loop communication link to a dispenser interface module and to a main board of the fuel dispenser. As supplied by an OEM of the dispenser, the main board of a dispenser typically has a connector for connecting conductors of a two-wire current loop to a station server inside a building of a gas/diesel fuel station. By using the y-harness, which essentially connects two sets of two conductors at common plug at one end of each set, with the common plug connected to the connector of the OEM main board, the other end of one set of conductors connected to the conductors of the communication current loop link to the server, and the other end of the other set of conductors connected to the dispenser interface module, the dispenser interface module can detect signal levels that exist on the communication current loop link between the dispenser main board and the gas station server without interfering with or disrupting those signals that exist on the communication current loop link.

In an aspect, the managing of the main board includes retrieving data from the main board via a data port of the main board (the data port is not a connector for the two wire current loop) and the retrieving of the data from the main board occurs only when the monitoring of the pump signal levels indicates that the fuel dispenser is idle.

In an aspect, the retrieving may occur only while the fuel dispenser is idle and according to a predetermined, or periodic, schedule.

In an aspect, the managing of the main board includes retrieving fuel dispenser historical data from the main board via a data port of the main board of the fuel dispenser, and wherein the managing of the main board further includes: compressing the fuel dispenser data retrieved via the data port to result in compressed fuel dispenser data that does not include data except for data that the fuel dispenser has generated since a previous iteration of retrieving of fuel dispenser historical data, and transferring the compressed fuel dispenser data to a communication module for communication of the compressed fuel dispenser data to a remote server.

In an aspect, the method may further comprise receiving the compressed fuel dispenser data, for example with the remote server, and processing the received fuel dispenser data, or information. The processing may include determining the existence of one or more conditions associated with the fuel dispenser based on the received compressed fuel dispenser data. The remote server may generate a dashboard interface that indicates the one or more existing conditions. The generated dashboard may include a map and may place an indication of the dispenser, as well as its corresponding existing condition, substantially at the geographical location of the fuel dispenser. The determination of the geographical location may be based on coordinates received with the fuel dispenser data, or may be based on cross referencing in a table an identifier (received in a communication from the communication module of a dispenser) associated with the dispenser, an identifier associated with the main board of the dispenser, an identifier associated with the dispenser interface module of the dispenser, or an identifier associated with the communication module of the dispenser. The server may determine one or more corrective action(s) recommendation(s) based on the one or more conditions determined to be currently existing. The server may generate a dashboard interface that indicates the corrective action recommendation. The dashboard interface that indicates the corrective action recommendations may be generated as a display that is part of the dashboard that shows the location of the dispenser experiencing the condition on a map. Or, the dashboard interface that indicates the corrective action recommendations may be generated as a display that is a separate display than the dashboard that displays on the map. It will be appreciated that dashboards may be displayed as web pages or as displays of an application that is not a web page browser, such as an app running on a user's smart phone, or other similar user equipment device. It will also be appreciated that the remote server may comprise a fixed-location computer device or may comprise a mobile user equipment device. If a mobile user equipment device generates dashboards and makes corrective action recommendations, the mobile user equipment device may access information stored in it, or it may access information stored at a fixed location computer device.

In an aspect, the method may further comprise receiving the compressed fuel dispenser data and combining the received compressed fuel dispenser data with previously received compressed fuel dispenser data to create uncompressed fuel dispenser data. Thus, the uncompressed fuel dispenser data/information may include information relative to a long history of a given fuel dispenser, or a dispenser main board. By only transmitting compressed dispenser data from a given dispenser (as described elsewhere herein, compressed data may refer to fuel dispenser data that has only been generated since a previous transmitting of fuel dispenser data from a given dispenser), use of wireless network resources is minimized for a given transmission of dispenser data from a dispenser, but the remote server can have access to a given dispenser's full historical condition information, which a main board of a given dispenser may not be able to store due to memory size limitations on the dispenser main board. The method may determine one or more existing conditions associated with the fuel dispenser based on the received compressed fuel dispenser data and generate a dashboard interface that indicates the one or more existing conditions. The server may determine a corrective action recommendation based on the one or more existing conditions and based on historical dispenser data from the uncompressed fuel dispenser data that may not be included in the compressed dispenser data transmitted during a given transmission from a dispenser's communication module. The server may generate a dashboard interface that indicates the corrective action recommendation.

In an aspect, a fuel dispenser may be retrofitted according to steps of a method comprising connecting a dispenser interface module to a main board of the fuel dispenser via a current-loop connection at a current loop connection of the main board. The method includes also connecting the dispenser interface module to the main board via a data port of the main board, wherein the current loop connection is not connected to the data port, thus there are two different data connections between the main board and the dispenser interface module. It will be appreciated that the dispenser interface module only ‘listens’ to signals on the two-wire loop and does not put signals into the two-wire loop and does not disturb the signals on the two-wire current loop. The method also may include providing a communication module and connecting it to the dispenser interface module via a data connection, such as a serial data link such as a USB cable and associated connectors, such that data retrieved via the data port of the main board is provided for communication via the communication module via a wireless link to a communication network and on to a remote analytics and management server that is in communication with the communication network. It will be appreciated that data embodied in signals on the two-wire current loop may not be provided to the communication module for communication to the server

In an aspect the current-loop connection may be a y-harness that connects an existing gas station's current loop communication link to the dispenser interface module and to the main board of the fuel dispenser, and the electronics of the dispenser interface module substantially do not disturb signals that traverse the current-loop communication link.

### BRIEF DESCRIPTION OF DRAWINGS

FIG. 1 illustrates an environment comprising a retail fuel station with a plurality of fuel dispensers in wireless communication with a data analytics and management server.

FIG. 2 illustrates components of a fuel dispenser that is managed wirelessly.

FIG. 3 illustrates components of a dispenser interface module and a communication module used to manage a fuel dispenser.

FIG. 4A illustrates a bock diagram of circuitry used to detect and to recreate message information communicated serially between a fuel dispenser and a dispenser server.

FIG. 4B illustrates a screen shot of signal levels detected on a current loop as compared to pump thresholds and store thresholds.

FIG. 5 illustrates a y-harness to couple a dispenser interface module with a dispenser main board without disrupting serial communication between a fuel dispenser and a dispenser server.

FIG. 6 illustrates a block diagram of a plurality of fuel dispensers, each including a dispenser interface module and corresponding communication module, coupled to a fuel station server via two-wire current loop communication links.

FIG. 7 illustrates a block diagram of a plurality of fuel dispensers in communication with a remote dispenser fleet management and processing server.

FIGS. 8A-8E illustrate examples of various management user dashboard interfaces that may be presented to a user of a dispenser fleet management server application.

FIG. 9 illustrates a flow diagram of a method for detecting that a fuel dispenser is idle and retrieving data from the dispenser while the dispenser is idle.

FIG. 10 illustrates a flow diagram of a method for receiving a command and causing a corresponding action to occur at a dispenser only while the dispenser is idle.

### DETAILED DESCRIPTION

As a preliminary matter, it will be readily understood by those persons skilled in the art that the present invention is susceptible of broad utility and application. Many methods, embodiments, and adaptations of the present invention other than those herein described as well as many variations, modifications and equivalent arrangements, will be apparent from or reasonably suggested by the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise exclude any such other embodiments, adaptations, variations, modifications and equivalent arrangements, the present invention being limited only by the claims appended hereto and the equivalents thereof.

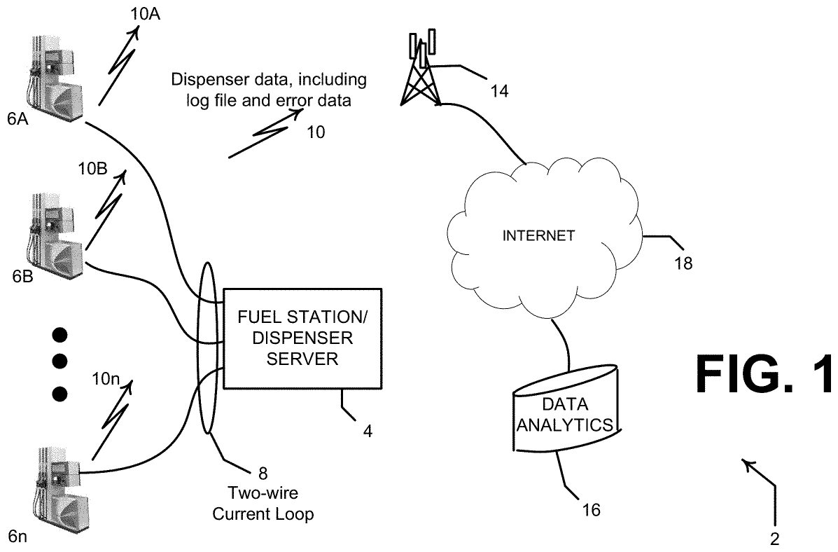

Turning now to the figures, FIG. 1 illustrates an environment 2 with a fuel station server 4 connected to a plurality of fuel dispensers 6A-6n. Fuel dispensers 6 communicate with fuel station server 4 via a two-wire current loop 8. The two-wire current loop network 8 communicates information, such as dispenser usage metrics and fueling transaction information associated with a given dispensing of fuel from a given fuel dispenser 6. The fueling transaction information communicated via two-wire current loop network 8 may include encrypted customer payment information that is transmitted to a fuel dispenser server within fuel station 4. Fuel station server 4 may communicate approval information generated by the fuel dispenser server to one or more of the plurality of fuel dispensers 6 so that a customer may proceed with dispensing fuel to his or her vehicle. Upon receiving approval/permission information via the two-wire current loop 8, the given dispenser 6 may be operated by a user, such as a customer or a station attendant, to dispense fuel to a customer's vehicle, fuel container, or other means for receiving fuel from the dispenser.

During operation of one of the fuel dispensers 6, a dispenser may generate operational information, including information such as number of gallons dispensed, time of dispensing, time of the beginning of dispensing, time of the ending of dispensing, any error messages or error codes that may relate to a component of the fuel dispenser environmental information such as moisture content or temperature of the tank containing fuel that the dispenser dispenses, and other information pertinent and relevant to the dispensing of fuel from the dispenser. Operational information may be generated by a component of a fuel dispenser 6 and may be stored on that component. Operational information may be retrieved from the component that stores operational information via a serial port connection. Operational information may be provided on current loop 8 to a server in fuel station 4. For purpose of discussion herein, reference to server 4 may be understood as referring to a fuel server that is typically located inside a fuel station building such as a gas station or convenience store. In relation to aspects disclosed herein and described in reference to other figures, current loop 8 shown in FIG. 1 may comprise multiple components, including a connector 38 and communication link 37, as shown in other figures.

Continuing with discussion of FIG. 1, operational information/data may be stored in the fuel dispensers 6 and transmitted from one or more of the dispensers via corresponding wireless links 10. The operational information may be transmitted via link 10 to a long-range wireless communication network 14, such as, for example, an LTE network, a 3G, a 4G, a 5G, or other similar wireless communication network. The operational information may be communicated between the wireless communication network 14 and a data analytics and management server 16 via the network 18. Wireless communication network 14 may comprise one or more wireless networking technologies, including Global System for Mobile Communications (GSM), Enhanced Data GSM Environment (EDGE), Long Term Evolution (LTE), wideband code division multiple access (W-CDMA), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), and/or Wi-MAX. Network 18 may comprise the Internet, a satellite communication network, a wide area network (WAN), a medium area network (MAN), a local area network (LAN), other similar types of communication networks, or a combination of any of these types of networks.

Two-wire current loop 8 typically conveys information from one or more of the dispensers 6 that may be detected and analyzed by a novel dispenser interface module to determine whether the given dispenser is in use or is idle (i.e., idle meaning that the dispenser is or is not being used by a user to dispense fuel). Information conveyed between a dispenser 6 and gas station server 4 may be conducted as signals having levels that represent digital, or logical, 0s and 1s. Current amplitudes of a signal, or signals, transported on current loop 8 that fall within a predetermined range, such as between 4 mA and 50 mA, may represent a logical 1; amplitudes falling within another range, for example 4 mA or less may represent a logical 0 for communication in one direction along the current loop; and amplitudes falling within another range, for example, 50 mA or greater, may represent a logical 0 in the other direction. Preferably, while the dispenser is in use as indicated by a non-idle signal on two-wire current loop 8, operational information and control messages are not transmitted, received, or otherwise communicated via the serial port connection of the component that generates and stores the operational information (typically the main board of a dispenser). Such transmitting, receiving, or otherwise communicating of operational information, or dispenser information/data, is not communicated via the two-wire current loop 8 and is only communicated via the serial port of the dispenser's main board while the dispenser is idle. The component that generates and stores operational information, files, dispenser data, etc. and that may control many operations of a given dispenser generally includes processing circuitry, including a microprocessor; is typically implemented on a circuit board; is generally referred to herein as a given dispenser's ‘main board;’ and is typically supplied with a dispenser as provided by the dispenser's original manufacturer.

To minimize usage of resources on wireless link 10, a component of a given fuel dispenser 6 may parse, compress, process, or modify operational data retrieved from the component that stores the operational data before causing the operational data to be transmitted via the long-range wireless link 10.

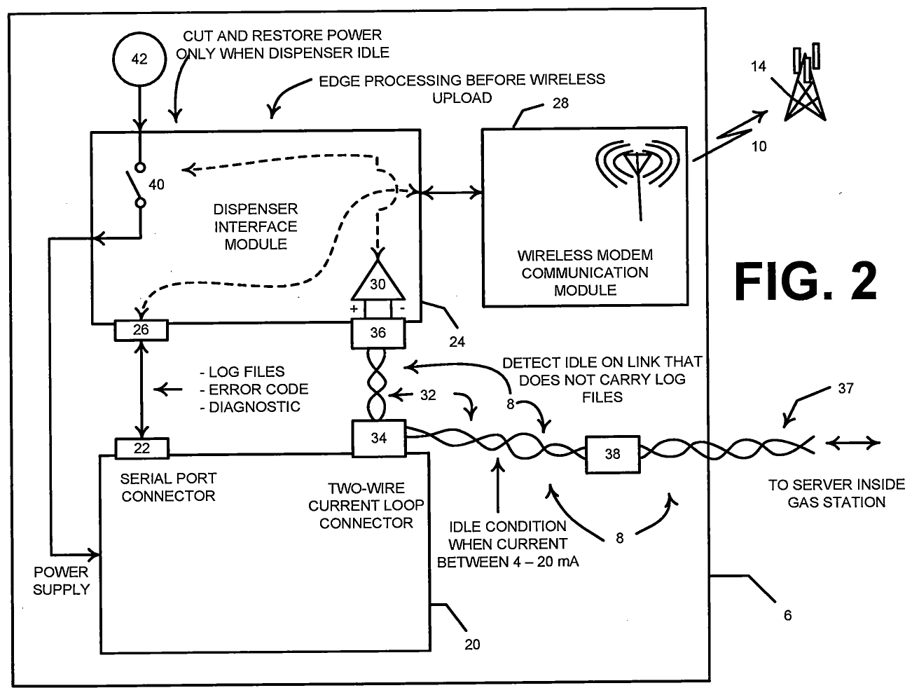

Turning now to FIG. 2, the figure illustrates components that may be included in a fuel dispenser 6. A given fuel dispenser 6 may include main board 20, which may be a board in the given fuel dispenser as delivered by the original equipment manufacturer (“OEM”) that manufactures the dispenser. Main board 20 may be a component of a given fuel dispenser 6 that generates and stores operational data. Main board 20 may make such operational data available at its serial port 22. Dispenser interface module 24 may request, retrieve, or otherwise obtain operational data with a dispenser interface from serial port 22 at communication port 26, which may be a serial port type complementary to the type of port 22, which ports may be connected via a serial cable and may communicate serially via a given serial communication protocol. In an aspect, the dispenser interface may be a serial port connector that connects to port 26. In another aspect, the dispenser interface may be one or more conductors for transferring digital serial signals that are permanently attached and connected to dispenser interface module 24 and that have a serial port connector for coupling to port 22 of main board 20. Dispenser interface module 24 may process operational data retrieved from main board 20 and may communicate operational data to communication module 28 which may then communicate the operational data via long-range wireless communication link 10 to long-range wireless communication network 14. Communication module 28 may include a wireless modem.

Dispenser interface module 24 may include a differential amplifier circuit 30 coupled with two-wire current loop 8 to determine when dispenser 6 is idle. Dispenser interface module 24 may couple to current loop 8 with y-harness 32. Y-harness 32 may include a y-adapter connector 34 to provide connections for two conductors of current loop 8 to: main board 20 via a main board current loop connector 34, to dispenser interface module 24 via dispenser interface module current loop connector 36, and to a station current loop communication link 37 (which may provide connectivity between a dispenser and a dispenser server at, or in, a fueling station) via a station current loop connector 38. Thus, instead of referring to current loop 8 as shown in FIG. 1, which illustrates general current loop connections between dispensers 6 and a station server 4, reference may be made herein to communication link 37 being current loop conductors that run to server 4 when describing y-harness 32 connecting dispenser interface module 24 and main board 20 to server 4 via the current loop communication link at connection 38.

Dispenser interface module 24 may determine that main board 20 needs to be restarted to clear an error code, to ‘unfreeze’ the main board, or for some other purpose. Upon determining that dispenser 6 is idle by evaluating signal levels on two-wire current loop 8, (idle signal levels will be described in more detail infra), dispenser interface module 24 may cause switch 40 to interrupt power from power supply 42, which may not only provide power to the dispenser interface module but may also provide power to main board 20. Thus, for example, after determining that a reboot of main board 20 is necessary or desirable, and upon determining that fuel dispenser 6 is idle based on signal values on two-wire current loop 8 corresponding the dispenser, dispenser interface module 24 may interrupt and then reconnect power from power supply 42 to main board 20.

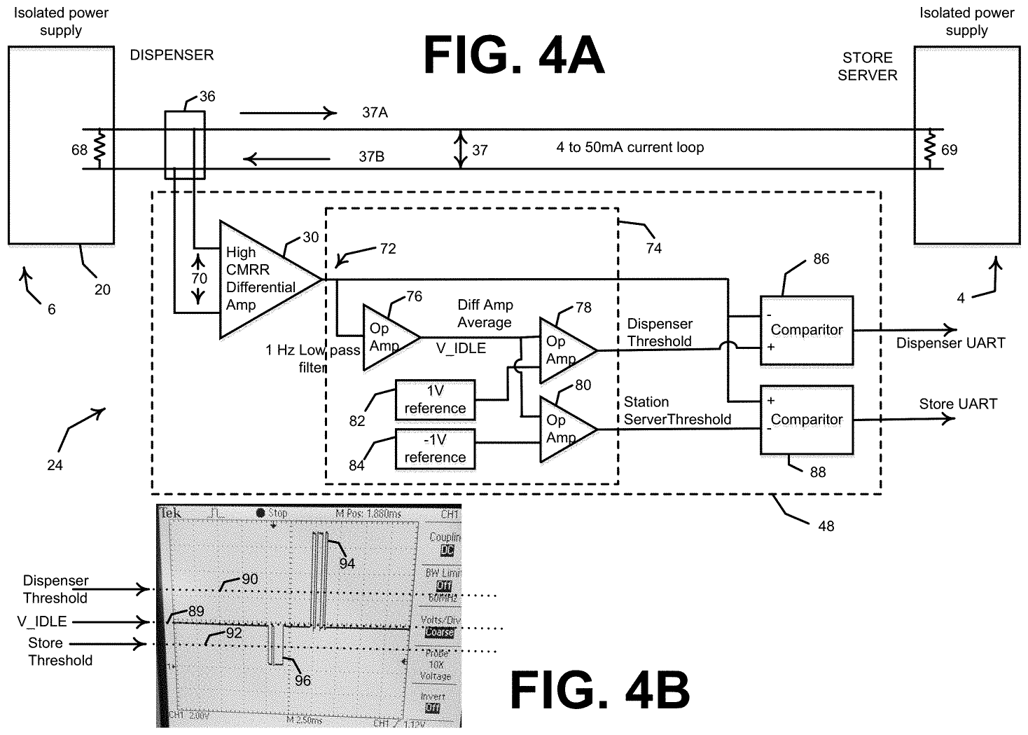

In an aspect, instead of taking the action of interrupting power to main board 20 to reboot the mainboard, dispenser interface module 24 may determine, from an evaluation of signals on two wire loop 8, that dispenser 6 is idle and then retrieve information from, or send command signals, messages, or other information to, main board 20 via ports 22 and 26. The figure indicates that an idle condition may exist when current signal amplitudes detected on loop 8 are at levels that fall in an idle condition current range between 4 and 50 mA. However, the idle condition current range may be selected as being bounded by different current values than 4 and 50 mA. Furthermore, as will be described below at least in reference to FIGS. 4A and 4B, circuitry of dispenser interface module 24 may apply a threshold cushion to a value that is determined as defining an idle condition. Cushion values may be used to facilitate accurate determination of a logical zero from current values sensed on current loop 8. For communication in one direction on current loop 8, a logical 0 may be determined when a signal's current value is less than the lower value of an idle condition current value (i.e., a value of 4 mA would be a logical 0) by an amount equal to or greater than the cushion value, and a logical 0 for communication on the loop in the other direction may be determined when a signal's current value on the loop exceeds the upper value of the idle condition current value by an amount equal to or greater than the cushion value. Accordingly, applying cushion values may create an idle condition current range substantially equal to the sum of the absolute values of the threshold values, with the range being based on the idle condition current value. The idle condition current value would be substantially a mid-point value of the idle condition current range if a threshold value corresponding to current on loop 8 in a given direction has substantially the same absolute value as the absolute value of a threshold value corresponding to current on loop 8 in the other direction. As discussed in more detail supra, in an aspect 1-volt cushion values are applied to voltage difference levels that correspond to current values sensed as existing on loop 8 as shown in FIG. 4A as thresholds before determining that current signals on loop 8 correspond to a given dispenser 6 being in an idle condition (i.e., a user or customer is not using, or in the processing of using, the given dispenser).

Continuing with description of FIG. 2, broken lines shown inside dispenser interface module 24 are not meant to depict actual electrical connections, but to indicate and highlight functionality that a processor of the interface module may manage or facilitate while signals on link 8 correspond to a dispenser 6 being in an idle condition, which functionality may include interrupting power to main board 20 or communicating information via communication module 28 and the main board.

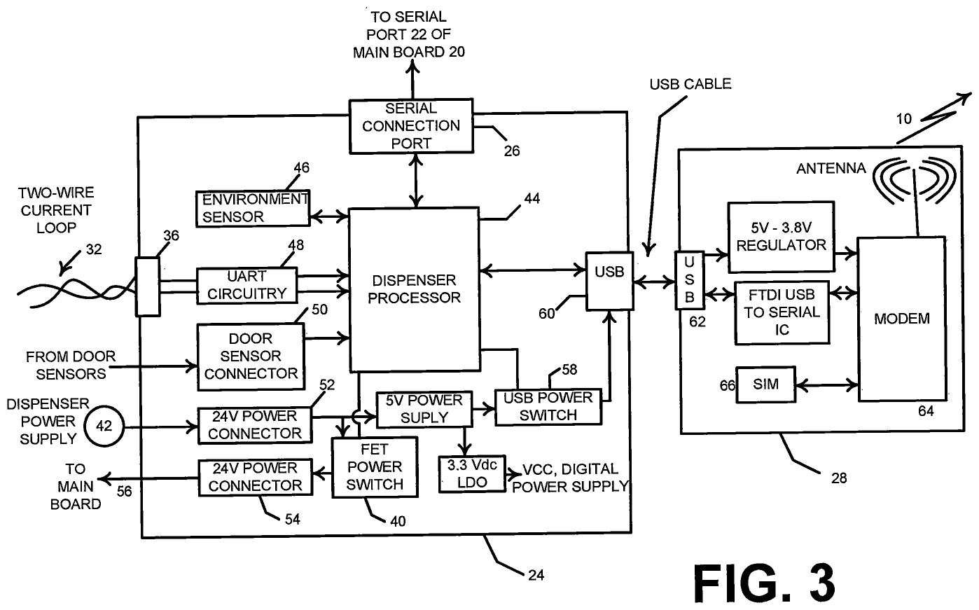

Turning now to FIG. 3, the figure illustrates a block diagram of novel dispenser interface module 24 coupled to communication board 28. Dispenser interface module 24 is shown in the figure with humidity and/or temperature sensor 46. Sensor 46 may be a single sensor or may represent discrete sensors that couple with processor 44. Additional sensors not shown that may be coupled with processor 44 include, but are not limited to, a microphone, a barometer, an accelerometer, a strain gage, and the like. Dispenser interface module 24 includes UART circuitry 48, that may be referred to herein as second dispenser interface circuitry. Circuitry 48 couples via connector 36 with a communication link that runs between a fuel dispenser 6 and a dispenser management station, such as a gas station, convenience store, truck stop, fuel plaza store, and the like as shown in FIG. 1. The communication link may be two-wire current loop 8. Circuitry 48 does not disrupt signals that pass between the dispenser and the dispenser management station on communication link 8.

Continuing with discussion of FIG. 3, processor 44 of dispenser interface module 24 connects to a door sensor 50 that may detect tampering with a security door of a fuel dispenser 6, or that may provide the status of such as door as being open or closed. Dispenser interface module 24 receives power at connector 52 from power supply 42 as shown in FIG. 2. Processor may control the supply of power to main board 20 on a power link 56 connected from the main board to connector 54 via switch 40. Switch 40 may be a mechanical relay, transistor circuitry, an FET power switch, an SCR, a Triac, or similar switching device that may be controlled by processor 44.

Processor 44 may also control switch 58 to regulate, provide, or interrupt power being provided at connector 60, which may be a serial port connector such as a Universal Serial Bus (“USB”) connector.

Communication module 28 connects to dispenser interface module 24 via a serial connection, such as a USB connection via connector 62. Data, messages, or commands received from dispenser interface module 24 may be provided to communication module 28 for communication via wireless modem 64, which is shown in the figure as a U-Blox brand cellular processor but may be a different type or brand of cellular processor. Modem 64 may include a Wi-Fi processing circuit, Bluetooth® processing circuitry, Z-wave or other circuitry for facilitating communication via other wireless protocols. It will be appreciated that dispenser interface module 24 and communication module 28 may be implemented as separate circuitry on separate respective circuit boards, separate circuits portions of a System on a Chip (“SOC”) or, may be implemented as circuit portions on a single circuit board. In an aspect, communication module 28 may be implemented as a short range wireless modem such as Wi-Fi, Bluetooth®, Z-wave, or similar, and may be configured to communicate to a nearby having a modem, either a wired or long-range-wireless modem (such as cellular, LTE, 5G, etc.), which would then provide a connection to communication network 18 as shown in FIG. 1. Modem 64 may facilitate, and support wireless communication according to, CAT-M1 technology, architecture, and protocols.

Turning now to FIG. 4A, the figure illustrates a block diagram of UART circuitry 48. Circuitry 48 interfaces with station current loop communication link 37 at dispenser interface module current loop connector 36. As discussed supra, a y-harness may actually couple circuitry 48 with link 37 at connection 36 to effectively tap the station communication link such that a fuel dispenser's main board is directly connected to a station server that is remote from the dispenser while providing a parallel electrical connection from the current link to dispenser interface module 24. However, the y-harness is not shown in FIG. 4A for purposes of clarity.

Current loop sensing amplifier 30 is preferably a differential amplifier, that may be implemented using an operational amplifier (“op amp”) integrated circuit (“IC”) or may be implemented using discrete electronic components. Inputs 70 of amplifier 30 detect voltage levels between link conductors 37A and 37B, which voltage levels are proportional to current flowing in current loop 37. Output 72 of amplifier 30 is proportional to the current difference between link conductors 37A and 37B and the corresponding voltage difference present at inputs 70.

In an aspect, when a fuel dispenser 6 communicates with a dispenser server 4, located in a gas station building for example, messages may be transmitted from the dispenser to the server as digital bits with current levels near 50 mA representing a digital/logical ‘zero’, or 0, and current levels near 20 mA as a digital/logical ‘one’, or 1. Messages may be transmitted from server 4 to dispenser 6 on current loop 37 as digital bits with current levels near 4 mA representing a digital/logical 0 and current levels near 20 mA as a digital/logical 1. Resistors 68 and 69, at the dispenser end and server end of current loop communication link 37, respectively, translate current on the current loop communication link into voltage levels that are presented at inputs 70 of differential amplifier 30.

Output 72 of amplifier 30 is fed to threshold determining block 74. Threshold determining block 74 includes idle voltage determining amplifier 76. Idle voltage determining amplifier 76 may be configured, via biasing or feedback loop resistors, and low pass filter components (which are not shown for clarity), to output a steady DC voltage that corresponds to the average current on current loop 37. The average current on loop 37 practically corresponds to amplitude of current on the loop that represents a logical 1 based on the assumption that because a logical 1 is represented in serial communication signals in either direction between dispenser 6 and server 4 by the same current level on link 37, (i.e., nominally about 20 mA) this most common amplitude level therefore is the average signal level of signals on the loop. Moreover, because communication between dispenser 6 and server 4 share a logical 1 current value on current loop communication link 37, a logical 1 for an extended, configurable, predetermined period may be assumed to represent a period during which dispenser 6 is idle (i.e., not being used by a customer to dispense fuel).

The output from idle voltage determining amplifier 76, which averages voltages at output 72 that corresponds to an average current value on communication link 37, may be referred to as V_idle. V_idle is directed to an input of dispenser threshold amplifier 78 and to an input of server threshold amplifier 80. Outputs of +1V dispenser reference voltage source 82 and −1V server voltage reference source 84 are provided to the other inputs of dispenser threshold amplifier 78, and server threshold amplifier 80, respectively, which may both be configured to operate as summing amplifiers. By providing the +1V and −1V references to corresponding dispenser threshold amplifier 78 and server threshold amplifier 80, respectively, an idle voltage range is established such that a voltage at output 72 of amplifier 30 must exceed (1+V_idle) to indicate a logical 0 for a serial message being transmitted from dispenser 6 to server 4, and a voltage level must fall below (V_idle−1) to indicate a logical 0 for a serial message being transmitted from the server to the dispenser. Thus, the output of dispenser threshold amplifier 78 is a voltage level directed to a noninverting input of dispenser comparator 86 such that a voltage at output 72, which is directed to an inverting input of the dispenser comparator, must exceed the output of amplifier 78 to indicate a logical 0 for communication from dispenser 6 to server 4, and the output of server threshold amplifier 80 is a voltage level directed to an inverting input of sever comparator 88 such that a voltage at output 72, which is directed to an inverting input of the server comparator, must fall below the output of amplifier 80 to indicate a logical 0 for a communication from the server to the dispenser. A voltage at output 72 that falls between the voltages at outputs from the dispenser threshold amplifier 78 and the server threshold amplifier 80 indicates a logical 1 for communications between dispenser 6 and server 4 regardless of which is transmitting and which is receiving.

Thus, in an aspect, threshold determining block 74 determines, from output voltage levels at output 72, a range of voltages that correspond to a logical 1 level as represented by a signal level on current loop communication link 37 between dispenser 6 and server 4. In addition, if a voltage level at output 72 remains within the idle voltage range, as determined by block 74, for a predetermined period, dispenser 6 is assumed to be idle, or not in use by a user.

Turning now to 4B, a screen shot of a signal analysis display shows a V_idle voltage level 89 dispenser threshold level 90 and a server threshold level 92. In the screen shot, V_idle corresponds to an average current level on current loop communication link 37 that represents a logical 1 for communication, in either direction, between dispenser 6 and server 4. Signal amplitude 94 is shown with a level exceeding dispenser threshold 90 and thus indicates a representation of a logical 0 for communication from dispenser 6 to server 4. Likewise, signal amplitude 96 indicates a value falling below server threshold 92 and thus indicates a current on current loop communication link 37 representing a logical 0 for communication from server 4 to dispenser 6. It will be appreciated that the displacement in FIG. 4B between dispenser threshold 90 and server threshold 92 substantially corresponds to the difference between the output produced from +1V reference source 82 and −1V reference source 84 shown in FIG. 4A.

The outputs from comparators 86 and 88 are used by UART circuitry to recreate on dispenser interface module 24 messages information communicated serially on current loop communication link 37 from dispenser 6 to server 4, and from the server to the dispenser, respectively. The dispenser interface module may process the recreated message information for various purposes, including determining that dispenser 6 is idle (i.e., not being used by a consumer to dispense fuel), or to determine that an abnormal condition exists at dispenser 6.

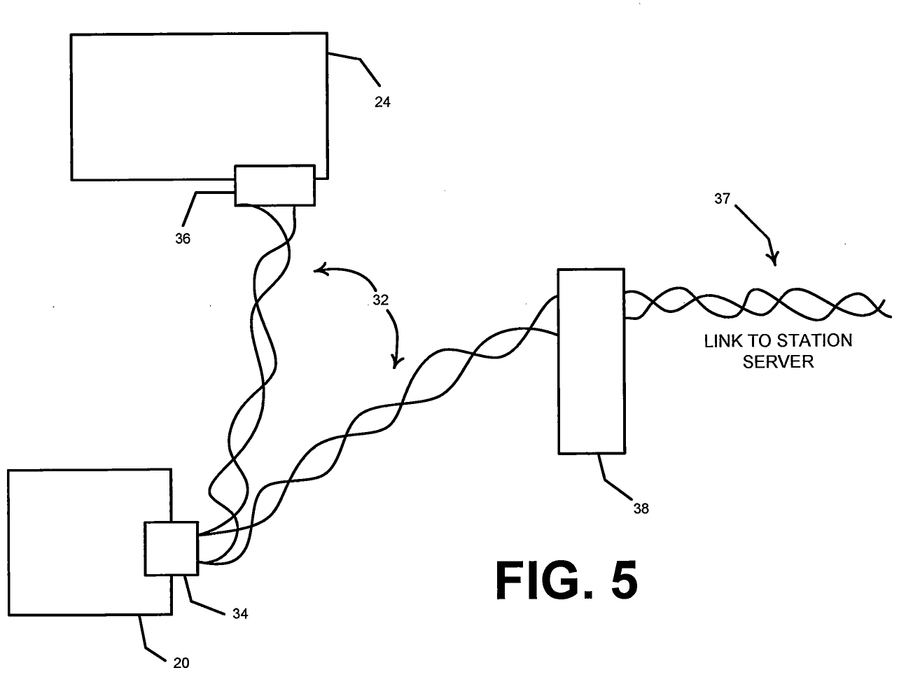

Turning now to FIG. 5, the figure illustrates y-harness 32. Without dispenser interface module 24, current loop communication link 37 may connect directly to connector 34 on main board 20. However, by using y-harness 32, which, in conjunction with a connector at connection 34, forms a ‘y’ in its conductors at connection 34, link 37 can be directly connected to main board 20 at connection 34 and dispenser module 24 may also be connected simultaneously to connection 34. Thus, dispenser interface module 24 can read signals that are present at connection 34 and link 37 remains directly connected to connection 34 of the main board. It will be appreciated that connections 34, 36, and 38 are referred to generally as connections, and it should be appreciated that such connections may be removable connections, typically via a male/female connector set. For example, module 24 and main board 20 may include female connection sockets that make up part of connections 36 and 34, respectively. In addition, conductors of y-harness 32 and conductors of communication link 37 may couple together at connection 38 with conductors of one terminating in a female socket and the conductors of the other terminating in a mating male plug.

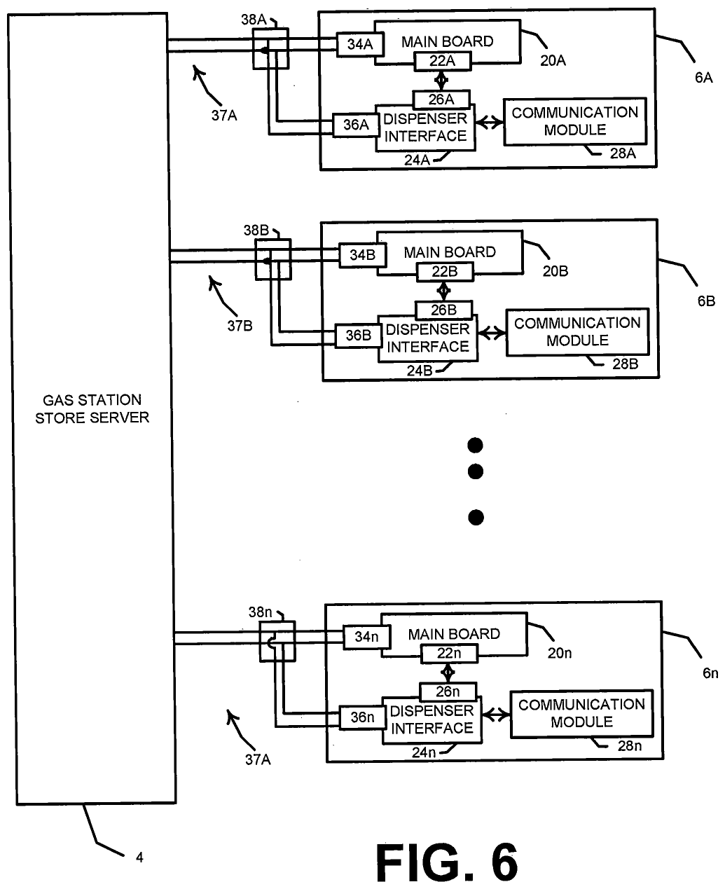

Turning now to FIG. 6, the figure illustrates a plurality of fuel dispensers 6 coupled to gas stations store server 4. Each dispenser 6 transmits serial information to server 4 via a corresponding communication link 37. At one end each communication link 37 couples to a port at server 4 and at the other end to connection 38. Connection 38 may comprise a connector of link 37 plugged in to a connector of y-harness 32. Each Y-harness 32 includes one branch that connects to a port on corresponding main board 20 and another branch that connects to a port on corresponding dispenser interface module 24. Each fuel dispenser module 24 couples with a corresponding wireless modem module 28 for transmitting and receiving data between the dispenser module 24 and a remote management and analytics server 16, which is not shown in the figure.

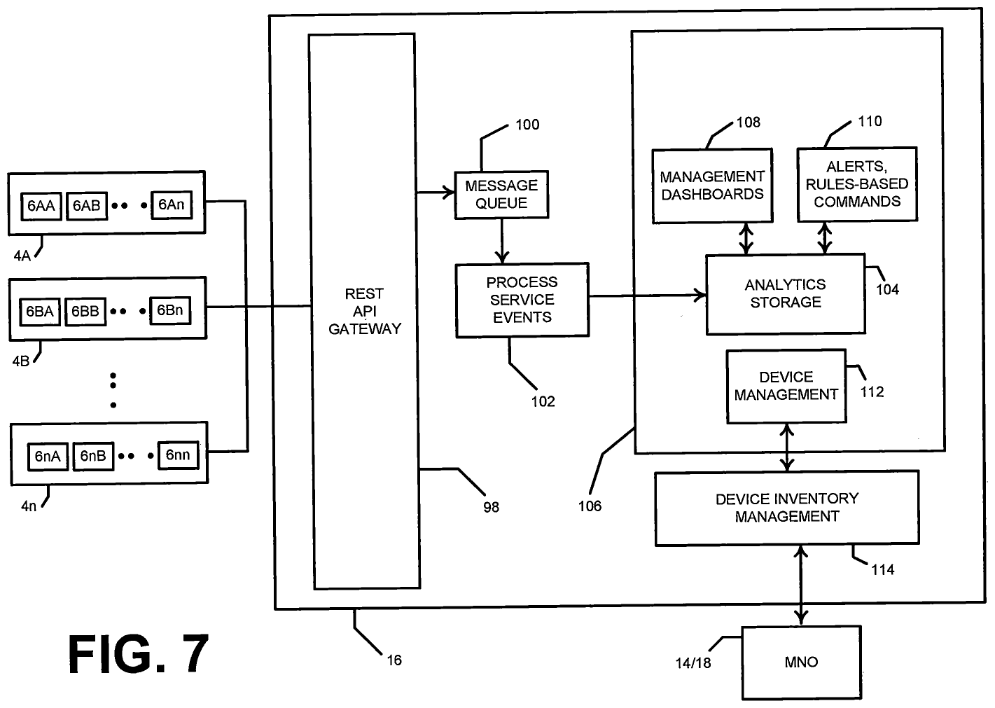

Turning now to FIG. 7, the figure illustrates a plurality of gas station servers 4, located at different respective locations, and with each server connected to a plurality of fuel dispensers 6 via a two-wire current loop communication link. The gas station servers 4 may connect logically with dispenser management and analytics server 16; the gas station servers may connect physically with the management and analytics server via a wireless communication network 14 and/or via a data network 18 such as the Internet. Dispensers 6 may connect logically with dispenser management and analytics server 16; dispensers may connect physically with the management and analytics server via a wireless communication network 14 and/or via a data network 18 such as the Internet. Server 16 may process log file data received over networks 14 and 18 from one or more of the plurality of servers 4 or from dispensers 6.

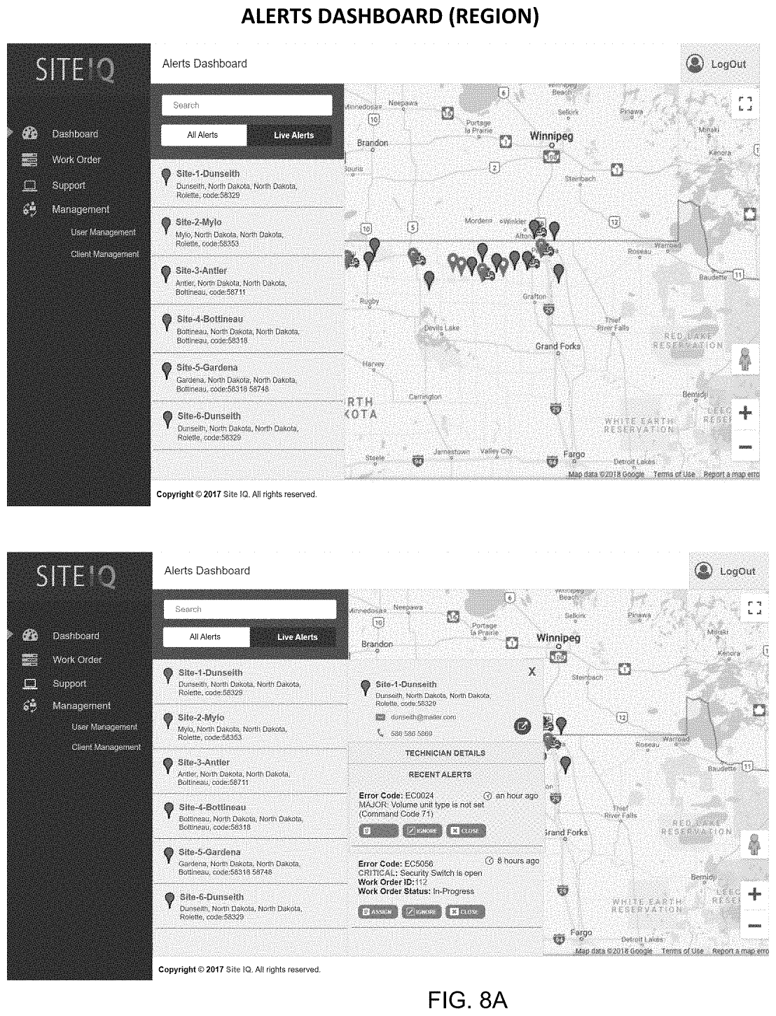

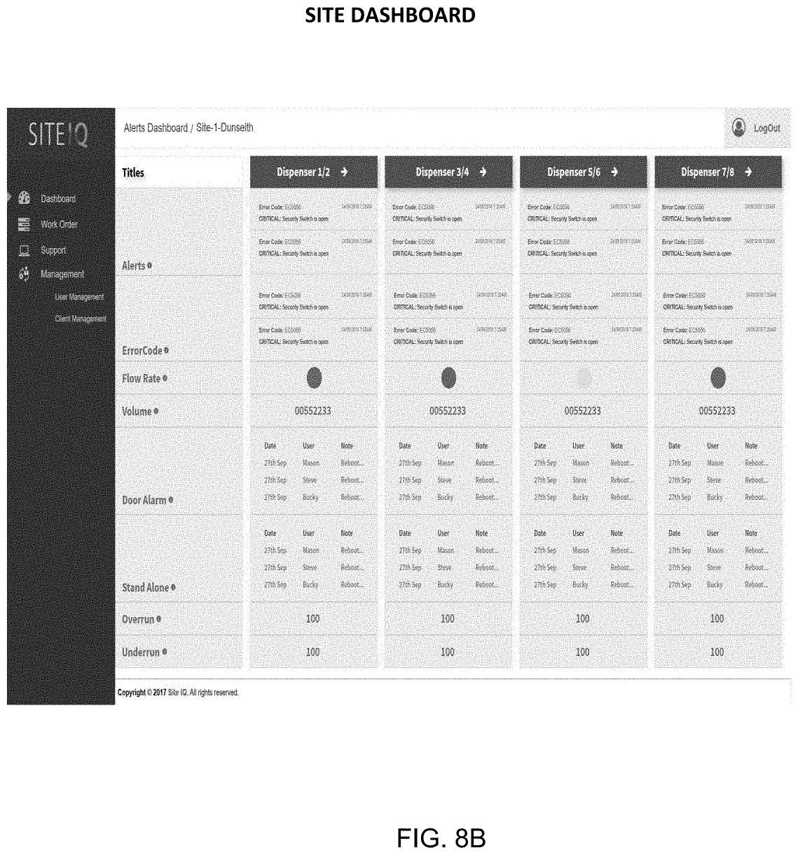

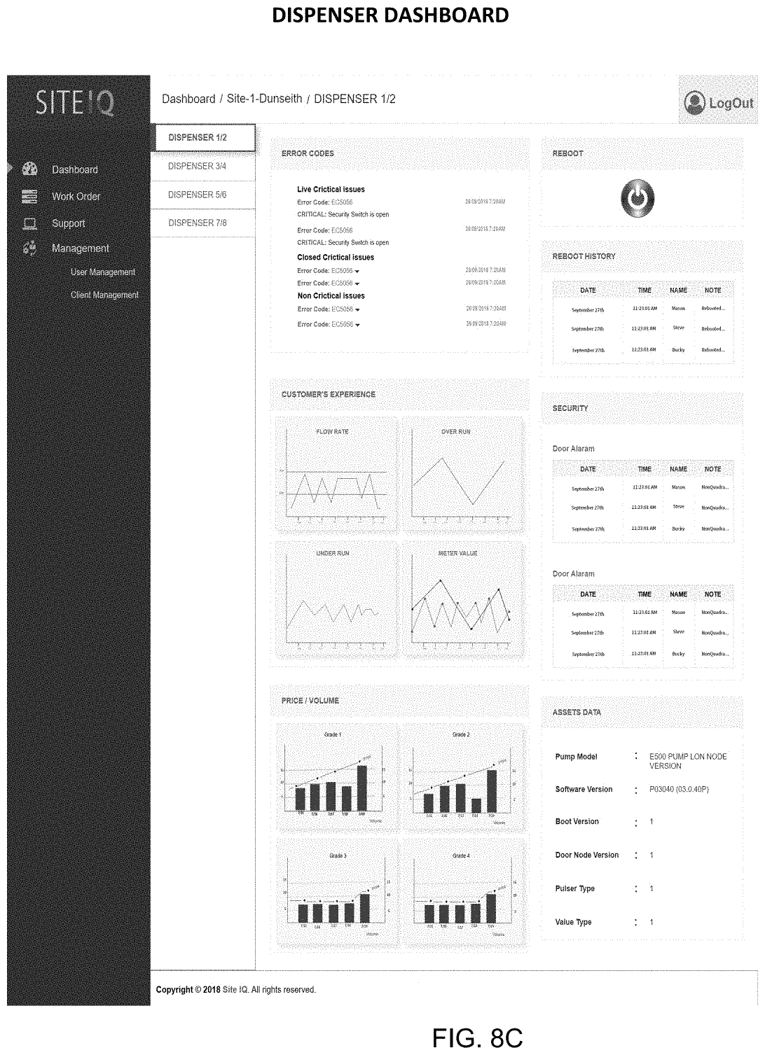

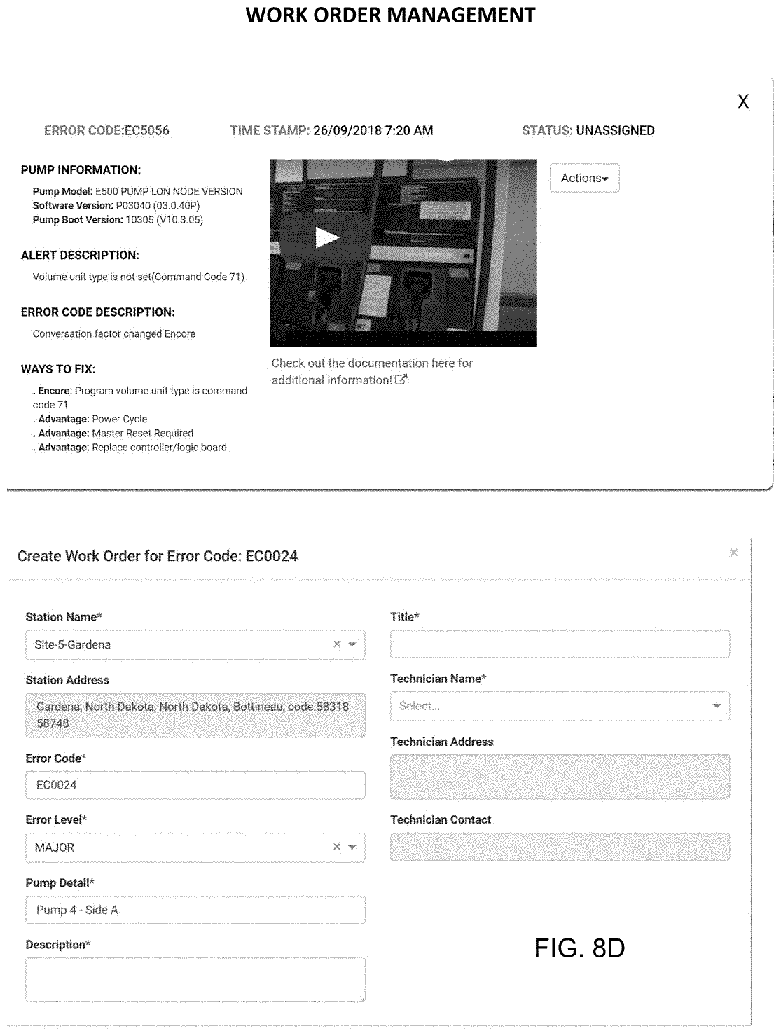

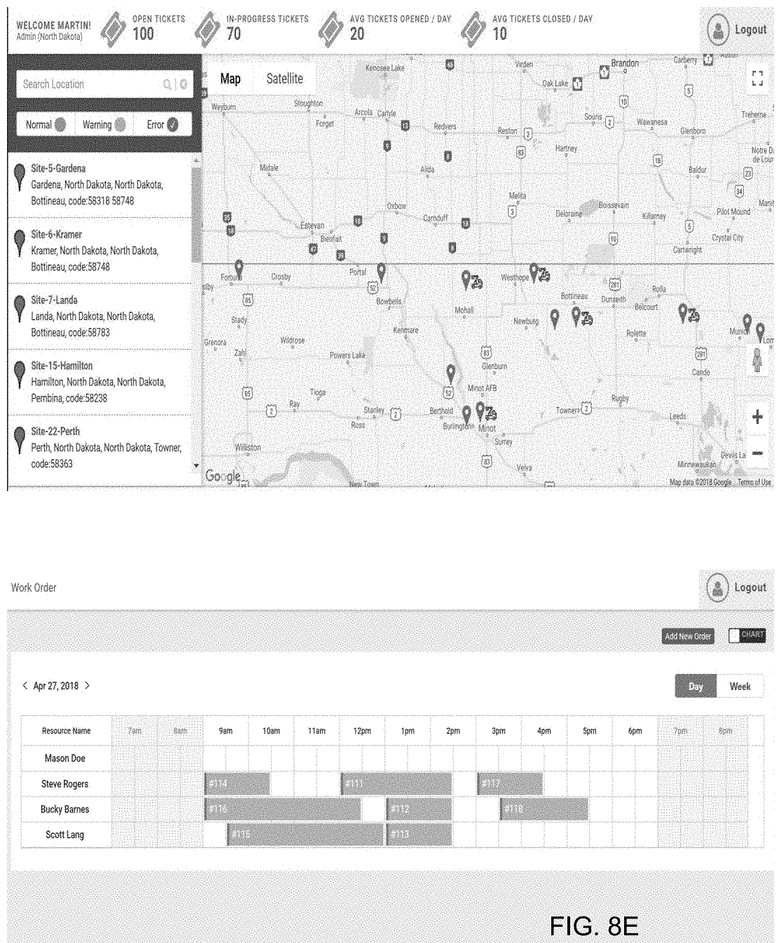

Server 16 may include REST server functionality, which may include functionality to interpret and process information, date, and files from a variety of different types of gas station servers 4 and from a variety of fuel dispensers 6. The REST functionality may be embodied or implemented via REST gateway 98, which may include functionality facilitated by and generated according to a fuel dispenser messaging API. Messages received via gateway 98 may be stored in a message queue 100 before being processed at block 102. Processed messages from block 102 may be stored in analytics storage block 104. Server 16 may process information stored in block 104 with interface processing block 106. Processing block 106 may include functionality to generate various user interfaces, which may be referred to as dashboards, with dashboard generator 108. Examples of dashboard interfaces are provided, infra, in FIGS. 8A-8E. Dashboards may be used by management personnel, typically working for an entity that manages dispensers 6 and servers 4 at multiple physical locations.

Management personnel may use dashboards to create or modify rules for generating alerts regarding dispensers 6 or servers 4 using alert rules engine block. Management may manually issue alerts based upon their personal evaluation of information pertaining to one or more of dispensers 6 or servers 4. Or, rules engine 110 may automatically generate alerts based on information received from servers 4 or dispensers 6. Alerts may be transmitted to servers 4, to dispensers 6, or to user devices, such as computers or smartphones of service technician personnel who service and work on dispensers 6 and servers 4. Alerts may include commands that are transmitted to dispensers 6 according to unique identifiers of communication modules 28 or dispenser interfaces modules 24, as disclosed elsewhere herein. Commands may include directions for a service technician to physically visit a given dispenser 6 or server 4 according to location information and work load information associated with the technician as well similar information associated with other technicians. Dashboard generator 108 may work in conjunction with device management user interface generator 112 to produce the dashboards. In such a scenario, dashboard generator 108 may determine information to provide to the interface generator 112, and then provide the information to the interface generator, which may determine how to present the information to a user and how to receive input from the user to update or control the sending of commands or alerts.

Device inventory management processing block 114 may receive information generated by sensors at dispensers 6, such as, for example, number of gallons of fuel remaining in an in-ground storage tank that a given dispenser pumps fuel from. Processing block 114 may receive information from sensors at a given dispenser 6 such as the status of a dispenser compartment door, humidity at the dispenser's location, amount of water in an in-ground storage tank, error codes associated with a given dispenser or its components, and the like. Device management block 114 may provide such sensor information to dashboard generator 108 which may provide such information to interface generator 112 for presentation to a user. A user interface generated by generator 112 may include various control items presented on a touch screen display, audio invitations to provide information manually through a touch screen or via voice commands through a microphone.

The device management user interface may provide a way to manage the sensors and provision them for use with a given dispenser. A device administration manager may look at the active sensors at different gas station locations to see if they are working properly and sending data properly to an analytics server. Provisioning of deployed sensors may include authorizing them for communication with the analytics server, which may include a REST API gateway.

A Rest API Gateway may comprise a collection of web servers to accept payload from sensors that provide gas station pump metrics and to write the payload into a message queue for further processing. This API gateway may be configured to send commands back to a dispenser interface module, or to sensors themselves.

The messaging queue may perform further processing to make the payloads intelligible and may project future issues that may arise with a given dispenser, or groups of dispensers, by analyzing data received from one or more dispenser interface modules. Data received at an analytics server may be stored in a persistent data store to facilitate users of a dashboard user interfaces to understand and manage potential or ongoing issues at one or more fuel dispensers.

An analytics user interface may allow dashboard users to read data from the persistent data store. A dashboard user interface may present a current status/health of one or more fuel dispenser at various locations. Users may be able to look at the stored data in a timeline fashion to see the health or progress of fuel dispenser errors and may provide a way for dispenser administrators to assign issues at gas stations to technicians and view the status and repair progress relative to those issues until resolution. Technicians may be able to log onto this system and view the issues assigned to them along with error code, corresponding descriptions, and corrective action recommendations associated with one or more fuel dispensers.

Turning now to FIGS. 8A-8E, the figures provide screen shot examples of user interfaces that present dashboard views of dispenser information that may be received at a management server. The dispenser information may be received from a plurality of fuel dispensers located at a plurality of different fuel stations (i.e., information from multiple dispensers at different gas stations). The information from the different dispensers may have been transmitted wirelessly by a communication module in communication with a dispenser interface module in each of the dispenser. The top half of FIG. 8A shows a map with alerts indicated by graphical pushpins displayed on the map at locations corresponding to locations of the dispensers that generated the alert information. The bottom screen of FIG. 8A shows information that may pop up when a pointing device, such as a mouse, is hovering over one of the pushpins for “Site-1—Dunselth” shown on the upper screen, with additional information being displayed proximate the corresponding pushpin being hovered over.

FIG. 8B shows a screen shot of a table view of information received from each of multiple dispenser interface modules and corresponding communication modules.

FIG. 8C shows a screen shot of a management dashboard where Dispenser 1/2 has been selected. The Dashboard shows multiple error codes and their associated criticality levels. Graphical display portions show graphical representation of dispenser information, including fuel flow rate, dispenser over run, dispenser under run, and meter value. Other graphical displays illustrate price/volume for different grades of gasoline. The right portion of the dashboard shows reboot history of the main board of the dispenser, which may have been wirelessly initiated from a remote device and implemented by the dispenser interface module while the dispenser is idle as discussed elsewhere herein, without a dispenser technician physically going to the dispenser and manually rebooting the main board. Door open alarms, and dispenser hardware and software data are also shown. The information shown in FIG. 8C may have partially, or totally, been transmitted by using a dispenser interface module and communication module at the dispenser as discloses elsewhere herein.

FIG. 8D shows a work order interface. The top portion of the figure displays information relative to a given dispenser that may have been wirelessly transmitted from a communication module of the dispenser, as disclosed elsewhere herein, and the bottom portion of the figure shows data items for inputting information for creating a work order for a technician. The information input items used to generate the work order may partially be automatically populated, may be totally automatically filled in, or may be manually filled in/selected by a user of the interface.

FIG. 8E shows a screen shot of a user interface for displaying work orders for technicians who are physically dispatched to repair dispensers that may not be remotely reset.

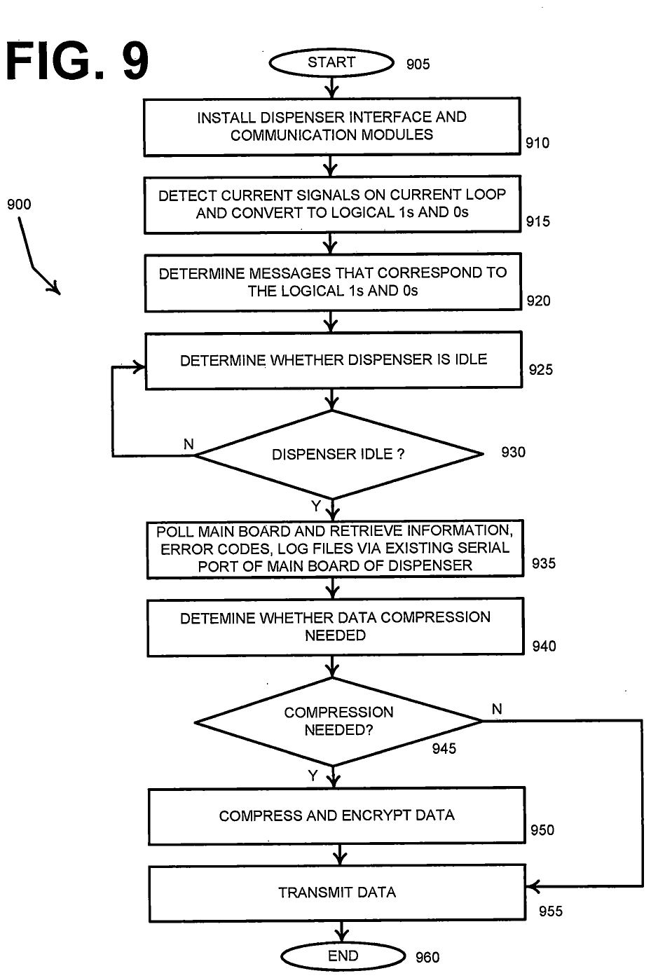

Turning now to FIG. 9, the figure illustrates as flow diagram of a method 900 for determining that a fuel dispenser is idle and retrieving information from the dispenser while the dispenser is idle. Method 900 begins at step 905. At step 910 a field technician installs a dispenser interface module and a communication interface module into a secure compartment of a fuel dispenser. The dispenser interface module and communication interface module may be separate components or may be both part of a single component such as a circuit board. A y-harness may be used to connect the dispenser interface module with a two-wire current loop communication link between the dispenser, a dispenser server and the dispenser interface module. The installed y-harness provides for a direct electrical connection via the current loop between a main board of the dispenser that existed before installation of the dispenser interface module, and a dispenser server, which direct connection existed before installation of the dispenser interface module. After the dispenser interface and communication modules have been installed in the dispenser at step 915 the dispenser interface module detects current signals on the current loop and converts the signals to logical ones and zeros. At step 920 the dispenser interface module processes the logical ones and zeros corresponding to an information message, or messages, traversing the two-wire current communication link and may determine the contents of the message. At step 925 the dispenser interface module determines whether there is currently an idle condition of the dispenser by determining that the contents of a message, or lack of a message, being conveyed over the two-wire current communication link indicate an idle condition. As discussed above, determination of an idle condition of a given fuel dispenser may correspond to a value corresponding to a logical one over a predetermined idle determination period. If current signals on the two-wire current loop do not correspond to a value that represents a logical 1 for the predetermined idle determination period, as determined at step 930, method 900 returns to step 925.

If at step 930 a processor of the dispenser interface module determines that an idle condition exists, method 900 advances to step 935. At step 935 dispenser interface module may poll the dispenser's main board and retrieve information, error codes, log files, and other data via an existing serial port of the dispenser's previously existing main board. At step 940 the dispenser interface board may determine whether retrieved data is of the type or size that warrants compression. For example, if a log file retrieved through the existing serial port of the main board includes numerous data records, some of which may have already been retrieved during a previous retrieval iteration through the serial port, the processor of the dispenser interface module may determine which data records have already been retrieved and uploaded and may determine that those previously retrieved data records may be excised, with a new/compressed version of the data files having the not-needed data records excised/removed. Such excising of previously uploaded data records may be referred to as data compression. By performing such data compression at the processor of the dispenser interface module only recently generated data records are further processed and transmitted from the dispenser.

However, some data retrieved at step 935 may not include data files that include data records that were previously retrieved or uploaded. Therefore, for some types of information, or data files, compression may not be needed.

At step 945 a processor of the dispenser interface module determines whether a determination was made at step 940 that a recently retrieved data file is of the type that should be compressed, and methods 900 advances to step 950 if a determination of compression as being preferable was made at step 940. At step 950, the processor of dispenser interface module performs compression of data and may perform encryption of the compressed data. If a determination is made at step 945 that data compression was not deemed as being needed, method 900 advances to step 955.

At step 955 the processor of the dispenser interface module forwards the compressed (and encrypted if encryption was performed at step 950) version of retrieved data if compression was required, or an uncompressed version (and encrypted if the processor is programmed to perform encryption of the uncompressed data) of the retrieved data if compression was not required, to the communication module for upload to an analytics server, the upload preferably occurring via a long range wireless communication network link, such as a cellular telephony data network link. Method 900 ends at step 960.

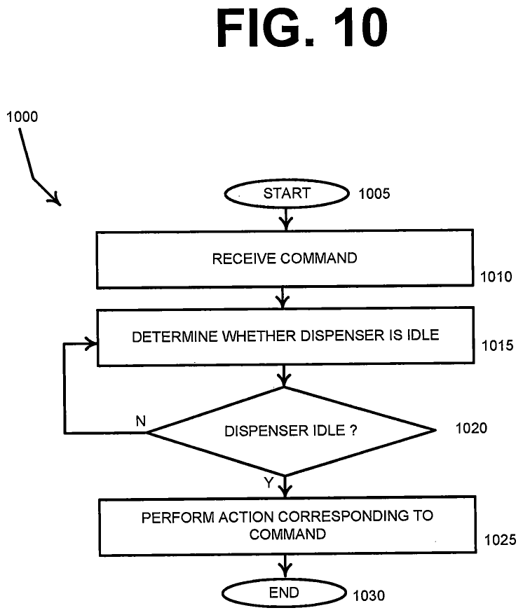

Turning now to FIG. 10, the figure illustrates a flow diagram of a method for receiving and processing a command at a fuel dispenser that includes a dispenser interface module and a communication module, the description of which is described elsewhere herein including in reference to the description of FIG. 9 above. Continuing with discussion of FIG. 10, method 1000 begins at step 1005. At step 1010, the dispenser interface module receives a command that was transmitted to the communication module from an analytics and management server that is remote from the dispenser. At step 1015, the dispenser interface module determines whether the dispenser is idle as described elsewhere herein. If a processor of the dispenser interface module determines at step 1020 that the dispenser is idle, the dispenser interface module causes implementation of an action corresponding to the received command to occur at step 1025. For example, if a data analytics management server has determined that the dispenser needs to restart or reboot and sent a message instructing that such an action be taken at a dispenser, the dispenser interface module may cause power from a power supply to be interrupted to a main board of the dispenser by operating a switch on the dispenser interface modules that is situated electrically in an electrical path through which power to the main board is supplied. After interrupting power, if the command received at step 1010 was to reboot the main board, the dispenser interface module may cause the switch to close to restore power to the main board. Or, if the command received at step 1010 was to interrupt power until further notice (e.g., until a technician visits the dispenser to perform a repair), the dispenser interface module may cause the switch to remain open, thus preventing power from the power supply from reaching the main board until another command is received instructing the dispenser interface module to close the switch to reconnect power to the main board. After the action corresponding to the command received at step 1010 has been performed, method 1000 ends at step 1030.

Regarding handling of data stored in the main board of a given dispenser, dispenser log files may be periodically retrieved from the main board. The dispenser interface module may interpret the retrieved dispenser data for processing. The retrieved data files may be compared with previously retrieved data to identify new data. The new data, while standing alone from the previously generated and retrieved data may be referred to as compressed data and may be encrypted for transmission by the communication module. The dispenser interface module may periodically command the cellular board to open connections to the cellular network based on determination that predetermined events have occurred. The compressed and encrypted dispenser data and event data may be transferred from the dispenser interface module to the cellular module to transmit the data to a communication networks, such as a cellular network.

The transmitted data is received at an analytics server, which may be operated by a services provider company, such as a company that provides analytic data to operators of fuel dispenser. At the analytics server, the received data may be decrypted and decompressed for analysis and presentation to the customer (i.e., operators/owners of fuel dispensers) via a web portal or a mobile application.

The analytics server may also send messages via communication network cloud infrastructure to the cellular communication module in forms such as SMS or internet protocol message that may be used by the dispenser interface module to control an action at a given dispenser. These message signals are forwarded from the communication module to the dispenser interface module. These message signals may be acted on by the dispenser interface module to cause the performing of a variety of actions including rebooting the dispenser, ingesting the latest log data and send the data, downloading new firmware to be installed on the dispenser's main board, and the like. The download-firmware command allows new features and commands to be deployed locally at each dispenser.

Methods, sequences and/or algorithms described in connection with the embodiments disclosed herein may be embodied directly in firmware, hardware, in a software module executed by a processor, or in a combination thereof. A software module may reside in RAM memory, flash memory, ROM memory, EPROM memory, EEPROM memory, registers, hard disk, physical and/or virtual disk, a removable disk, a CD-ROM, virtualized system or device such as a virtual servers or container, or any other form of storage medium known in the art. An exemplary storage medium is communicatively coupled to the processor (including logic/code executing in the processor) such that the processor can read information from, and write information to, the storage medium. In the alternative, the storage medium may be integral to the processor. Aspects disclosed herein may provide for a non-transitory machine and/or computer readable storage and/or media, having stored thereon, a machine code and/or a computer program having at least one code section executable by a machine and/or a computer, thereby causing the machine and/or computer to perform the steps as described herein.

What is claimed is:

1. A device, comprising:
a first dispenser interface coupled to a communication port of a fuel dispenser;
a dispenser interface module coupled to the first dispenser interface;
a communication module coupled to the dispenser interface module; and
wherein the dispenser interface module includes a dispenser interface module processor to:
receive first dispenser data from the first dispenser interface;
process the first dispenser data to create first processed dispenser data; and
cause the communication module to transmit the processed first dispenser data to an element of a communications network with which the communication module is configured to communicate.

2. The device of claim 1 wherein the communication module includes a long-range wireless communication modem.

3. The device of claim 1 further comprising a second dispenser interface that couples with a communication link between the fuel dispenser and a dispenser management station device that includes a two-wire current loop, wherein the second dispenser interface couples to second dispenser interface circuitry to obtain second dispenser data from signals passing on the two-wire current loop, and wherein the second dispenser interface circuitry does not disrupt signals that pass between the dispenser and the dispenser management station on the two-wire current loop.

4. The device of claim 1 wherein the dispenser interface module processor causes the communication module to transmit a message when the dispenser interface module processor determines that the first dispenser data or the second dispenser data indicate that the fuel dispenser has experienced an abnormal condition.

5. The device of claim 3 wherein the second dispenser interface couples to a high common mode ratio rejection differential amplifier circuit that detects the second dispenser data from the communication link between the fuel dispenser and the dispenser management station and provides the second dispenser data to the dispenser interface module processor.

6. The device of claim 2 wherein the communication module includes a SIM that can operate on multiple mobile network operators' networks, and wherein the communication module includes a communication module processor to select which of the multiple mobile network operators' networks to operate on based on network metrics.

7. The device of claim 1 wherein the first dispenser data includes at least one data file, wherein the dispenser interface module processor is further to compare a current version of one of the at least one data file to a previous version of the one of the at least one data file, and to cause the communication module to transmit only differences between the current version and the previous version of the one of the at least one data file.

8. The device of claim 7 wherein the data condition is met when the first or second dispenser data indicate that the dispenser has experienced an abnormal condition.

9. The device of claim 1 wherein the processed first dispenser data includes less than all of the first dispenser data, wherein the processed first dispenser data includes first dispenser data that is relevant to a particular desired recipient and does not include first dispenser data that is not relevant to the particular desired recipient.

10. A method, comprising:
monitoring with a dispenser interface module dispenser signal levels of a main board of a fuel dispenser via a current loop connection; and
managing the main board with the dispenser interface module.

11. The method of claim 10, wherein the managing of the main board includes transmitting communication signals from the dispenser interface module to the main board but does not include transmitting communication signals from the dispenser interface module to the main board via the current loop connector.

12. The method of claim 10 wherein the managing of the main board includes interrupting power to the main board only when the monitoring of the dispenser signal levels of a main board of the fuel dispenser via the current loop connection indicates that the fuel dispenser is idle.

13. The method of claim 10 wherein the current loop connection includes a y-harness that connects an existing station's current loop communication link to a dispenser interface module and to a main board of the fuel dispenser.

14. The method of claim 10 wherein the managing of the main board includes retrieving data from the main board via a data port of the main board and wherein the retrieving of the data from the main board occurs only when the monitoring of the dispenser signal levels of a main board of the fuel dispenser via the current loop connection indicates that the fuel dispenser is idle.

15. The method of claim 10 wherein the managing of the main board includes retrieving fuel dispenser historical data from the main board via a data port of the main board of the fuel dispenser, and wherein the managing of the main board further includes:
compressing the fuel dispenser data retrieved via the data port to result in compressed fuel dispenser data that does not include data except for data that the fuel dispenser has generated since a previous iteration of retrieving of fuel dispenser historical data; and
transferring the compressed fuel dispenser data to a communication module for communication of the compressed fuel dispenser data to a remote server.

16. The method of claim 15 further comprising:
receiving the compressed fuel dispenser data;
determining one or more existing conditions associated with the fuel dispenser based on the received compressed fuel dispenser data;
generating a dashboard interface that indicates the one or more existing conditions;
determining a corrective action recommendation based on the one or more existing conditions; and
generating a dashboard interface that indicates the corrective action recommendation.

17. The method of claim 10 further comprising:
receiving the compressed fuel dispenser data;
combining the received compressed fuel dispenser data with previously received compressed fuel dispenser data to create uncompressed fuel dispenser data;
determining one or more existing conditions associated with the fuel dispenser based on the received compressed fuel dispenser data;
generating a dashboard interface that indicates the one or more existing conditions;
determining a corrective action recommendation based on the one or more existing conditions and based on the uncompressed fuel dispenser data; and
generating a dashboard interface that indicates the corrective action recommendation.

18. A method for retrofitting a fuel dispenser, comprising
connecting a dispenser interface module to a main board of the fuel dispenser via a current-loop connection;
connecting the dispenser interface module to the main board via a data port connection of the main board, wherein the current loop connection is not the data port connection; and
providing a communication module that communicates with the dispenser interface module via a data connection such that data retrieved via the data port connection of the main board is provided for communication via the communication module over a communication network to a remote analytics and management server that is in communication with the communication network.

19. The method of claim 18 wherein the current-loop connection is part of a y-harness for connecting an existing station's current loop communication link to the dispenser interface module and to the main board of the fuel dispenser and wherein electronics of the dispenser interface module substantially do not disturb signals that traverse the current-loop communication link.

20. The method of claim 19 further comprising:
connecting a power supply, which previously was connected to the main board, to a first side of a switch that is controlled by a processor of the fuel dispenser interface module;
connecting a second side of the switch to a power supply connection of the main board that the power supply was previously connected to; and
wherein the processor of the dispenser interface module will not instruct the switch to interrupt power to the main board when the processor determines that the fuel dispenser is in use based on a determination that signal levels on the current-loop communication link correspond to the dispenser not being in an idle condition.
